(19) United States
(12) Patent Application Publication
(10) Pub. No.: US 2024/0149152 A1
(43) Pub. Date: May 9, 2024

(54) GAME SUITES

(71) Applicant: Kilburn Live, LLC, Los Angeles, CA (US)

(72) Inventor: Charles KEEGAN, Celina, TX (US)

(21) Appl. No.: 18/500,026

(22) Filed: Nov. 1, 2023

Related U.S. Application Data
(60) Provisional application No. 63/382,136, filed on Nov. 3, 2022.

(51) Int. Cl. A63F 13/26; A63F 13/21; A63F 13/28

(52) U.S. Cl. CPC A63F 13/26; A63F 13/21; A63F 13/28

(57) ABSTRACT

Certain aspects of the present disclosure provide a game suite. The game suite includes a game bay including one or more walls, a ceiling, and a floor that at least partially enclose a gaming area; a plurality of user input interfaces configured to detect input from one or more users within the game bay; a projection mapping system configured to provide visual game content to a plurality of the one or more walls, the ceiling, or the floor; and a gaming entertainment system configured to execute a game within the game suite including: obtaining input from the plurality of user interfaces; and providing the visual game content to the projection mapping system responsive to the detected input from the plurality of user interfaces.

### CROSS-REFERENCE TO RELATED APPLICATIONS

This application claims benefit of and priority to U.S. Provisional Application No. 63/382,136 filed Nov. 3, 2022, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to an interactive gaming experience and, more particularly, to a game suites system providing a dynamic, modular, interactive, augmented reality gaming experience for a single user, multiple users, and even remotely connected users across multiple game suites or over a network.

### Description of Related Art

Gaming and entertainment has been steadily increasing in popularity. The last few decades have seen a rise from conventional card games and board games to video games. Video gaming itself has evolved from video game consoles to gaming on mobile phones and virtual reality headsets. Further, an industry and demand has grown for family fun centers, providing entertainment experiences such as laser tag, paintball, bowling, mini-golf, go-kart racing, trampoline parks, arcades, etc.

As new technologies emerge and as approaches to gaming change, there is a need for entertainment systems that leverage and improve these new technologies and that adapt to modern gaming preferences and demands to attract customers and provide new and exciting entertainment experiences.

### SUMMARY

One aspect provides a game suite. The game suite includes a game bay including one or more walls, a ceiling, and a floor that at least partially enclose a gaming area. The game suite includes a plurality of user input interfaces configured to detect input from one or more users within the game bay. The game suite includes a projection mapping system configured to provide visual game content to a plurality of the one or more walls, the ceiling, or the floor. The game suite includes a gaming entertainment system configured to execute a game within the game suite. Executing the game within the game suite includes obtaining input from the plurality of user interfaces and providing the visual game content to the projection mapping system responsive to the detected input from the plurality of user interfaces.

Other aspects provide a method by a gaming entertainment system. The method includes obtaining input from one or more users via one or more user input interfaces of a plurality of user input interfaces within a game suite. The method includes generating visual game content responsive to the input from the one or more users via the one or more user input interfaces. The method includes displaying projection mapped visual game content to a plurality of one or more walls, a ceiling, or a floor partially enclosing a gaming area of the game suite.

Other aspects provide a gaming entertainment system. The gaming entertainment system includes a memory comprising computer-executable instructions and a processor. The processor is configured to execute the computer-executable instructions and cause the gaming entertainment system to obtain input from one or more users via one or more user input interfaces of a plurality of user input interfaces within a game suite; generate visual game content responsive to the input from the one or more users via the one or more user input interfaces; and display projection mapped visual game content to a plurality of one or more walls, a ceiling, or a floor partially enclosing a gaming area of the game suite.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example game suite with a gaming entertainment system, according to one or more aspects.

FIG. 2 depicts an example of the gaming entertainment system, according to one or more aspects.

FIG. 3 depicts aspects of an example of modular game suites, according to one or more aspects.

FIG. 4 depicts aspects of example components of a gaming entertainment system, according to one or more aspects.

FIG. 5 depicts a method for providing a gaming experience, according to one or more aspects.

### DETAILED DESCRIPTION

Aspects of the present disclosure provide a system, apparatuses, methods, processing systems, and computer-readable mediums for a game suite system. In some aspects, the game suite provides an interactive gaming entertainment system and a lounge area. In some aspects, the game suite is modular and can be adapted to suit various environments. For example, the gaming entertainment system and lounge area may support multiple different configurations. In some aspects, multiple game suites may be provided together in a gaming center. In some aspects, multiple game suites within a gaming center can be physically arranged to provide a shared configuration. For example, multiple gaming entertainment systems may be arranged around a shared lounge area.

In some aspects, the lounge area provides an area for relaxation, socialization, eating, and viewing. In some examples, the lounge area provides access and viewing to the gaming entertainment system. The lounge area may provide direct viewing of the gaming entertainment system and/or one or more displays which may display the gaming entertainment system (e.g., a camera view of the gaming bay) and/or content associated with the gaming entertainments system (e.g., in game content, leaderboards, menus, and/or interactive displays interfacing with the game). In some aspects, the lounge area includes portions of the gaming entertainment system, allowing guests in the lounge area to participate with an on-going game being run by the gaming entertainment system.

In some aspects, the gaming entertainment system includes one or more of: a plurality of inputs, a plurality of sensors, a plurality of displays, physical game play props, and one or more processors. The gaming entertainment system may include a gaming bay coupled to the lounge area. The gaming entertainment system may also include inputs and displays located in the lounge area.

The game suites described herein are modular and can be adapted based on the number of users as well as the architecture of the particular facility. The game suites provide a gaming entertainment center in which groups of guests can visit to play, socialize, and eat. In addition, the game suites provide a gaming entertainment system that allows for a single player to play or for multiple players to play cooperatively or competitively. The multiple players may be located within the gaming bay, within the lounge area, across multiple game suites within a single entertainment center facility, via a network across multiple entertainment facilities, and/or at home or otherwise remotely. The gaming entertainment system is further adaptable to multiple different games. The gaming entertainment system can provide an immersive interactive gaming experiences, leveraging augmented reality, virtual reality, and physical props and effects. The gaming entertainment system also allows a variety of experiences by accepting user interaction to the game play via a plethora of inputs, including, but not limited to, motion detection, audio commands, touch screens, and handheld controllers.

### Example Game Suite

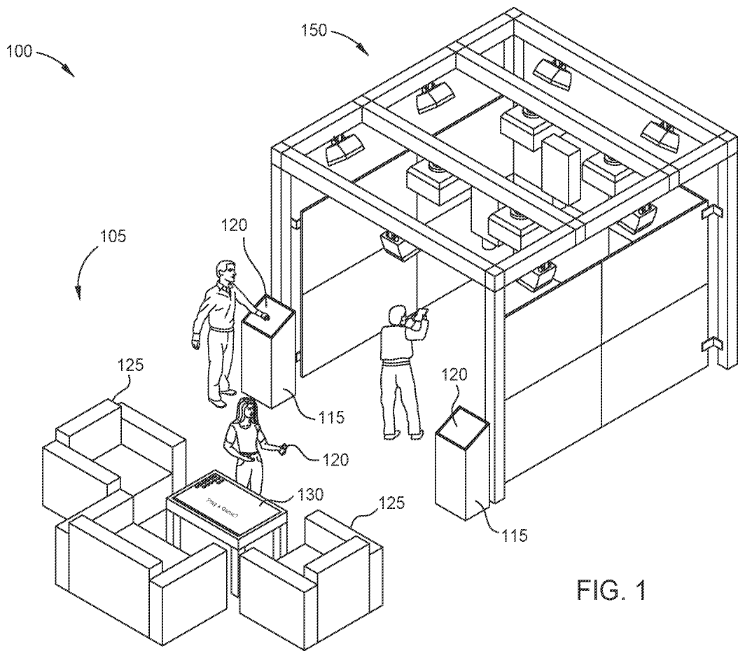

FIG. 1 depicts an example game suite 100 with a lounge 105 and a gaming entertainment system including a game bay 150, according to one or more aspects.

As shown in FIG. 1, the lounge 105 may be coupled with the game bay 150 to provide the game suite 100. As discussed herein, FIG. 1 shows only one example a game suite 100 configuration with a single game bay 150 that opens to the lounge 105. It should be understood that other configurations fall within the scope of this disclosure. In particular, the modular design of the game suite 100 allows for multiple configurations of the game bay 150 and lounge 105. For example, game suite 100 may include a shared lounge 105 coupled with multiple game bays 150 arranged about the shared lounge 105 in various patterns.

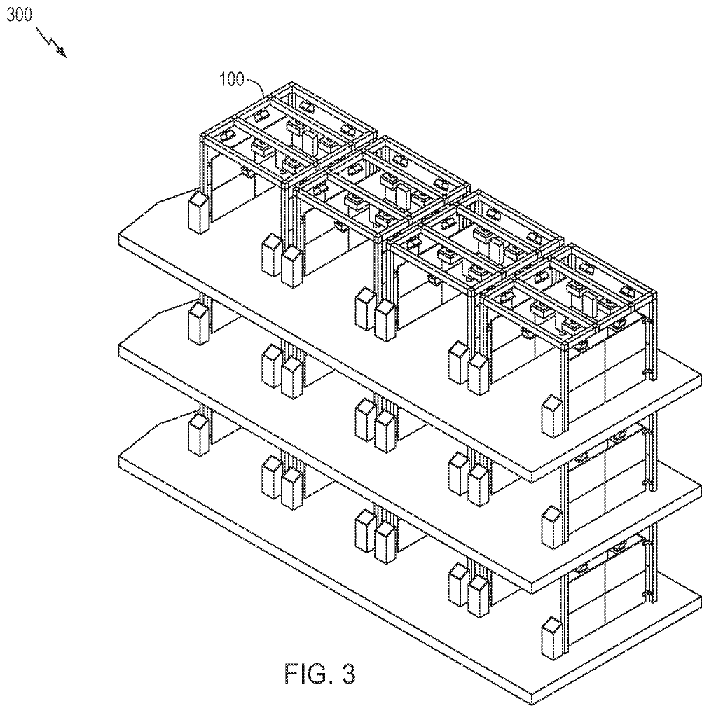

In some aspects, the game suite 100 may be located within a gaming entertainment facility. In some aspects, multiple game suites 100 may be located within the gaming entertainment facility. The multiple game suites can also be arranged in multiple different patterns within the facility, as discussed in more detail below with respect to FIG. 3.

As shown in FIG. 1, the lounge 105 may include seating 125, one or more displays 115, and one or more inputs interfaces 120. The lounge 105 may include additional furnishing and decor, such as tables, lighting, etc. It should be understood that the lounge 105 shown in FIG. 1 is one illustrative example, and that the lounge 105 may be configured in many different arrangements of seating 125, displays 115, input interfaces 120, and other furnishing and decor. In addition, while lounge 105 is shown in

FIG. 1 as an unenclosed area, in some aspects, lounge 105 may be partially or fully enclosed (e.g., with a door or other entry way).

In some aspects, guests within the lounge 105 may have access to the gaming bay 150. As shown, the guests within the lounge 105 may be able to view within the game bay 150 and observe players within the game bay 150.

In some aspects, guests within the lounge 105 can view the displays 115. Displays 115 may include, but are not limited to, kiosks, televisions, mobile phones, tablets, a smart table 130, and the like. In some examples, one or more of the displays 115 may display the game bay 150. For example, the displays 115 may provide camera footage, from one angle or from multiple different viewing angles, of the interior of the game bay 150 allowing the guests within the lounge 105 to watch the players within the game bay 150. In some examples, one or more of the displays 115 may display content associated with the game being played within the game bay 150, such as in-game content, leaderboards, scores, statistics, in-game menus, or other content associated with the game.

As shown in FIG. 1, the gaming entertainment system of the game suite 100 may include multiple different input interfaces. In some aspects, one or more input interfaces 120 are located in the lounge 105. The input interfaces 120 may allow guests within the lounge 105 to interact with the game being played by the guest, or guests, within the gaming bay 150. For example, as shown, the input interfaces 120 may include handheld controllers 120, touch screen kiosks 120, smart surfaces (e.g., such as the smart table 130 shown in FIG. 1), mobile devices (e.g., smart phones or tablets), motion sensors, and/or voice input interfaces allowing the guests within the lounge 105 to interact with the game being played in the gaming bay 150. In some aspects, multiple of the different input interfaces 120 may be used at the same time by different guests within the lounge 105 and within the gaming bay 150 to interact with the game. In some aspects, a smart table, such as the smart table 130 shown in FIG. 1, may include a touch screen display. The smart table 130 may include one or more other additional inputs, such as buttons, joysticks, track-pads, or other inputs. In some aspects, the smart table 130 can be used by guests within the lounge 105 to interact with the game being played in the game bay 150 and/or to play one or more separate games.

In some aspects, the game bay 150 is configured to allow players within the game bay 150 to interact with the gaming entertainment system for an immersive augmented reality game play experience. In some aspects, the game bay 150 is configured to interact with multiple players within the game bay 150.

In some aspects, the game bay 150 is configured with one or multiple projectors (e.g., as part of a laser projection system) configured to project visual content associated with a game onto one or more of the floor, one or more walls, or the ceiling of the game bay 150. In some aspects, the multiple projectors create an immersive, dynamic, and interactive, experience for the player(s) within the game bay 150. For example, content associated with the gameplay may be projected onto multiple surfaces of the game bay 150, such as the floor, ceilings, and walls, providing a 180° to 360° panoramic interactive projection mapped game about the player, simulating an immersive virtual experience as though the player is “within” the game. In some aspects, the game bay 150 uses projection mapping. Projection mapping may be used to turn irregular shaped surfaces and objects (e.g., such as physical props and/or other objects in the game bay 150) into display surfaces for visual projection of the in-game visual content.

In some aspects, the game bay 150 further includes one or more other displays (e.g., screens, TVs, etc.) configured to display additional content associated with the game. In some aspects, the game bay 150 further includes one or more loudspeakers configured to provide music, announcements, and/or audio content (e.g., digital surround sound) associated with the gameplay. In some aspect, the display provides additional information associated with the gameplay, such as leaderboards, scores, statistics, directions, announcements, or other information associated with the game.

In some aspects, the game bay 150 further includes one or more multiple physical props associated with the gameplay. In some aspects, the physical props are decorative. In some aspects, the physical props are connected props (e.g., a sword, gloves, or other physical prop associated with the gameplay that a player can interact with) that are interactive as part of the gameplay. In some aspects, the presence of the physical props further enhances the “realism” of the gameplay providing an immersive experience for the player.

In some aspects, the game bay 150 includes one or multiple “4D” components, configured to provide additional realism to the player's gameplay experience, such as wind, water spray, vibration, movement/tilt of the game bay 150, dynamic lighting effects, and/or other 4D effects associated with the game being played within the game bay 150.

In some aspects, the game bay 150 includes a plurality of sensors for detecting input from the player(s) within the game bay 150. In some examples, the game bay 150 includes motion sensors, face tracking sensors, gesture tracking sensors, body tracking sensors, audio sensors, touch sensors, 3D, and the like, and combinations of different sensors, as well as accompanying software for processing the sensor data. In some aspects, the game bay 150 includes multiple different types of the sensors for detecting input from the player.

In some aspects, the game bay 150 further includes one or more inputs to the gaming entertainment system (e.g., in addition to motion and/or voice detection sensors to detect input from the players). The additional inputs may include touch screens, handheld controllers, or other inputs.

In some aspects, the plurality of different inputs, provided at both the game bay 150 and at the lounge 105, allows asymmetric gaming, in which players can interact with the game in different ways and in a variety different roles via the different inputs.

In some aspects, the gaming entertainment system includes one or more processors configured to process input from the users, run the game being played, and output information to displays or other interfaces (e.g., to control the physical props and/or other 4D components), etc. In some aspects, part or all of the processing for the gaming entertainment system may be done remotely, such as by a remote server or on the cloud.

In some aspects, the gaming entertainment system stores in memory information about the players and guests. Certain information may be stored after a guest leaves, so when the guest returns to the gaming entertainment facility, the guest can seamlessly begin or continue gameplay. In some aspects, the player and guest information may be stored locally at the gaming entertainment facility or in a remote memory accessible by the gaming entertainment system.

In some aspects, the gaming entertainment system is configured to run a plurality of different games. The different games may be associated with different sensors, different props, different inputs, different projection mapping, different displays, etc. In some aspects, upon selection a game, the physical props, hardware of the space, and the game bay 150 itself (e.g., the room's scale) dynamically change to adapt the game bay 150 for the selected game.

In some aspects, the gaming entertainment system allows players within the game suite 100 (including players within the game bay 150 and/or players within the lounge 105) to interact with the selected game. In some aspects, the gaming entertainment system allows players across multiple game suites within a gaming entertainment facility, or across multiple gaming entertainment facilities, to interact with the game, play a game together, compete and compare scores, and/or chat with one another. In some aspects, the gaming entertainment system allows players within the game suite 100 to play with other players at any location via a network. In some aspects, the gaming entertainment system provides a connection to one or more social networks associated with the players.

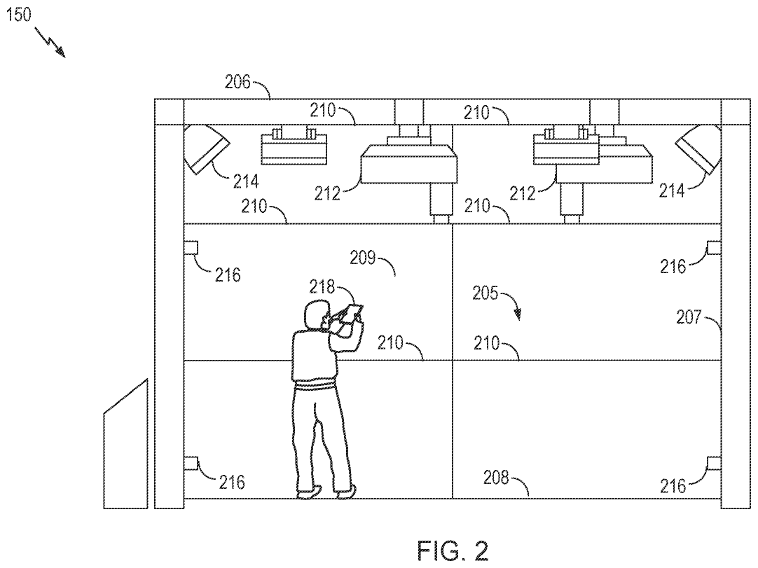

FIG. 2 illustrates an example of a game bay 150, according to one or more aspects. FIG. 2 shows only one example a game bay 150 configuration. It should be understood that other configurations fall within the scope of this disclosure. FIG. 2 provides a right-side cross-sectional view of the game bay 150 of FIG. 1.

As shown in FIG. 2, the game bay 150 comprises an enclosure 205. In some examples, the enclosure 202 may not be a fully enclosed space. As illustrated in FIG. 2, in one example, the enclosure 202 in substantially enclosed with a floor 208, a ceiling 206, and three walls (e.g., left wall 209, a front wall 207, and a right wall (not shown in this cross-section)), with one wall left open (e.g., a back side of the enclosure 205 is open) to the lounge 105 to provide a viewing area into the game bay 150 for the guests within the lounge 105. In some example, the enclosure 205 may be fully enclosed (e.g., with a door or other entry way). Further, while FIG. 2 shows enclosure 205 as cubic, the enclosure 205 may be other shapes, including irregular shaped configurations (e.g., as a dome, or with a curved wall). In addition, the enclosure 205 may be modular and adaptable to form different shapes depending on the selected game being played.

As shown in FIG. 2, walls of the enclosure 205 may include a plurality of panels 210. The panels 210 may be used by a projection mapping system to display visual content associated with a selected game being played.

Although not shown in FIG. 2, the enclosure 205 may further include one or physical props, as discussed herein.

As shown in FIG. 2, the game bay 150 includes projectors 212. As discussed above, the projectors 212 may be a laser projection system or visual content projection system. The projectors 212 may use projection mapping to display visual content on multiple surfaces of the enclosure 205, including panels 210, and/or the one or more physical props.

In some aspects, the enclosure 205 further includes one or more displays. The one or more displays may be used in addition to or alternative to the projectors 212. In some aspects, one or more the panels 210 may be display screens or TVs configured to display visual content associated with the selected game being played.

It should be understood that the panels 210 and projectors 212 in FIG. 2 show one example configuration. The game bay 150 may include different numbers of panels 210, different numbers of projectors 212, and the panels 210 and projectors 212 may be positioned at different locations within the game bay 150.

As shown in FIG. 2, the game bay 150 includes one or more loudspeakers 214. The loudspeakers 214 may provide audio content associated with the selected game being played, communications with other players or guests within the lounge 105, and/or announcements from the gaming entertainment facility. In some examples, the loudspeakers 214 provide digital surround sound audio. It should be understood that the loudspeakers 214 in FIG. 2 show one example configuration. The game bay 150 may include different numbers of loudspeakers 214 of different types (e.g., built in speakers, mobile speakers, wearable speakers, sound bars, etc.) at positioned at different locations within the game bay 150.

As shown in FIG. 2, the game bay 150 includes a plurality of sensors 216. As discussed herein, the plurality of sensors 216 may include sensors configured to track movements of players within the game bay 150, such as 3D motion sensors, face tracking sensors, gesture tracking sensors, body tracking sensors, and the like, or a combination of such sensors. In addition, the plurality of sensors 216 may include audio sensor configured to detect sounds (e.g., voice commands) from the players within the game bay 150. In addition, the plurality of sensors 216 may include one or more touch sensors (e.g., force sensors and/or capacitive sensors) configure to detect manual input from the players within the game bay 150.

As shown in FIG. 2, the game bay 150 includes one or more user inputs 218 to the gaming entertainment system (e.g., in addition to the motion detection sensors, voice detection sensors, and touch detection sensors that allow the players to interact with the gaming entertainment system). The additional inputs 218 may include handheld controllers, or other inputs. A handheld controller input 218 may function as a connected physical prop associated with the selected game being played, such as, for example, a steering wheel, a throttle, a gun, a bow, a fishing rod, a bat, or the like.

Although not shown in FIG. 2, the game bay 150 may include further “4D” components discussed herein to enhance the players immersive experience. For example, the game bay 150 may include fans to simulate air movement or wind, dynamic lighting to simulate various lighting effects associated with the game (e.g., indoor lighting, outdoor lighting, shadows, lighting, explosions, or other visual effects), heating or cooling to simulate effects of hot or cool sensations associated with a game being played, equipment to spray, drip, splash, or squirt water (or other liquid material) onto the players within the game bay 150 to simulate liquid effects associated with the game being played, equipment to cause the players within the game bay 150 to vibrate to simulate effects associated with the game being played, and/or equipment to provide motion effects to the players within the game bay 150 (e.g., movement of the game bay itself, movement of a stage or the floor on which the players stand, etc.) to simulate effects associated with the game being played.

FIG. 3 depicts aspects of an example configuration 300 of modular game suites 100, according to one or more aspects. As discussed above, multiple game suites 100 can be configured, e.g., as part of a gaming entertainment facility. As shown in FIG. 3, the game suites 100 can be stacked in multiple stories of sets of game suites 100. It should be understood that the configuration 300 in FIG. 3 is illustrative of the modular nature of the game suites 100 design, and that game suites 100 can be configured according to many different configurations.

In some aspects, the gaming entertainment system is configured to provide an immersive experience of a game within the game bay 150 to “bring to life” the game being played, including existing popular games, new games, and/or customized games for the game bay 150. In some aspects, the gaming entertainment system creates an immersive augmented reality version of one or more board games. In some examples, the gaming entertainment system can be used to create augmented reality immersive battle games, challenge games, party games, or other games.

In one illustrative example, players within a game suite 100 may play a game in which players within the lounge 105 use touch sensor kiosks to place the digital game pieces on a digital board and to select locations to search for opponent's digital game pieces on the digital board. Once an opponent's digital game piece is found, motion tracked controllers within the game bay 150 are then used by the players within the game bay 150 to battle (e.g., to aim and to fire at and to maneuver game pieces defensively) each other's game digital game pieces.

In another illustrative example, players within a game suite 100 may play a game in which players within the lounge 105 use touch sensor kiosks to explore a game map (e.g., to travel between locations within a larger area, such as to move between rooms within a map) to enter a mini-map location. After moving to a new location, motion tracked controllers within the game bay 150 are then used by the players within the game bay 150 to explore the location (e.g., to search for clues) and interact within virtual objects within the location.

In yet another illustrative example, players within a game suite 100 may play a game in which players within the lounge 105 use touch sensor kiosks to move one or more digital game pieces around a digital board and to play one or more mini-games associated with the game pieces location on the digital board. Motion tracked controllers within the game bay 150 are used by the players within the game bay 150 to play one or more other mini-games associated with certain game piece locations on the digital board.

In yet another illustrative example, players within a game suite 100 may play a game in which players within the lounge 105 use touch sensor kiosks to purchase one or more “traps” and place the purchased traps at selected location on a digital game board. Motion tracked controllers within the game bay 150 are used by the players within the game bay 150 to race the players' digital game pieces around the digital game board. As the players race, the players may collect digital money at various locations on the digital game board. In addition, as the players race their digital game pieces around the digital game board, the players attempt to avoid the placed traps in an effort to complete the race in the fastest time possible and win the game.

In this way, the players within the lounge 105 interact with the selected game, in a first one or more roles, using a first one or more input interfaces, while the players within the game bay 150 interact with the selected game, in a second one or more roles, using a second one or more input interfaces, with the players within the game bay 150 interacting in an immersive experience.

### Example Components of Gaming Entertainment System

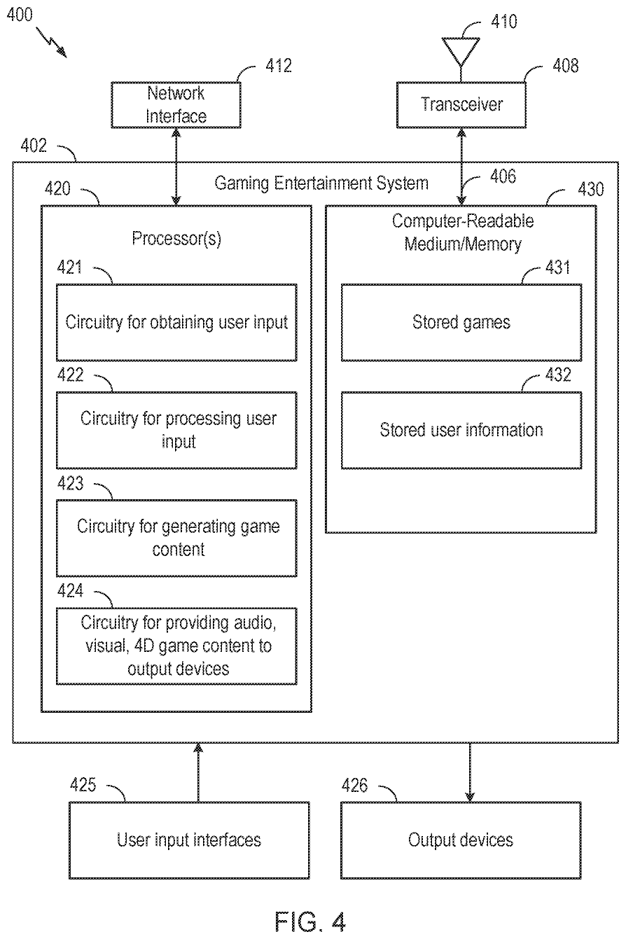

FIG. 4 depicts aspects of a gaming entertainment system 400. In some aspects, gaming entertainment system 400 is implemented in a game suite, such as game suite 100 described above with respect to FIGS. 1-3.

The gaming entertainment system 400 includes a processing system 402 coupled to a transceiver 408 (e.g., a transmitter and/or a receiver). The transceiver 408 is configured to transmit and receive signals for the gaming entertainment system 400 via an antenna 410. The processing system 402 may also be coupled to a network interface 412.

The processing system 402 may be configured to perform processing functions for the gaming entertainment system 400, including detecting input from one or more users, generating game content, and outputting game content for the one or more users.

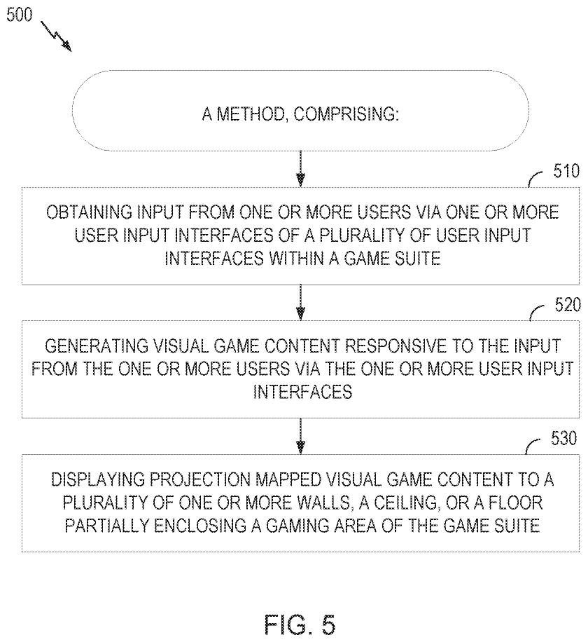

The processing system 402 includes one or more processors 420. The one or more processors 420 are coupled to a computer-readable medium/memory 430 via a bus. In certain aspects, the computer-readable medium/memory 430 is configured to store instructions (e.g., computer-executable code) that when executed by the one or more processors 420, cause the one or more processors 420 to perform the method 500 described with respect to FIG. 5, or any aspect related to it. Note that reference to a processor performing a function of the gaming entertainment system 400 may include one or more processors performing that function of the gaming entertainment system 400.

The one or more processors 420 include circuitry configured to implement (e.g., execute) the code stored in the computer-readable medium/memory 430, including circuitry for obtaining user input 421, circuitry for processing user input 422, circuitry for generating game content 423, and circuitry for outputting visual, audio, and/or 4D game content to one or more output devices 424. Processing with circuitry 421-424 may cause the gaming entertainment system 400 to perform the method 500 described with respect to FIG. 5, or any aspect related to it.

In the depicted example, computer-readable medium/memory 430 stores games 431 and user information 432.

As shown, the processing system 402 is coupled to user input interfaces 425 (e.g., motion sensors, audio sensors, handheld controllers, connected physical props, touch screens, etc.) and output devices 426 (e.g., projectors, display screens, loudspeakers, 4D components, etc.).

### Example Operations of a Gaming Entertainment System

FIG. 5 shows a method 500 for operations of a gaming entertainment system.

Method 500 begins at 510 with obtaining input from one or more users via one or more user input interfaces of a plurality of user input interfaces (e.g., motion input, gesture input, voice command input, touch screen input, hand held controller input) within a game suite (e.g., game suite 100).

Method 500 then proceeds to step 520 with generating visual game content responsive to the input from the one or more users via the one or more user input interfaces. In one aspect, the method 500 further includes generating audio game content and/or 4D effect game content responsive to the input from the one or more users via the one or more user input interfaces.

Method 500 further includes displaying projection mapped visual game content to a plurality of one or more walls, a ceiling, or a floor partially enclosing a gaming area of the game suite. In one aspect, method 500 further includes outputting the audio game content and/or 4D game content to one or more components of the game suite.

In one aspect, method 500 includes one or more operations for performing any of functions of the game suite described herein.

Note that FIG. 5 is just one example of a method, and other methods including fewer, additional, or alternative steps are possible consistent with this disclosure.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A game suite, comprising:
a game bay including one or more walls, a ceiling, and a floor that at least partially enclose a gaming area;
a plurality of user input interfaces configured to detect input from one or more users within the game suite;
a projection mapping system configured to provide visual game content to a plurality of the one or more walls, the ceiling, or the floor; and
a gaming entertainment system configured to execute a game within the game suite including:
obtaining input from the plurality of user input interfaces; and
providing the visual game content to the projection mapping system responsive to the detected input from the plurality of user input interfaces.

2. The game suite of claim 1, wherein the gaming entertainment system configured to:
receive a selection of a game to be played within the game suite; and
execute the selected game within the game suite.

3. The game suite of claim 1, further comprising one or more lounge areas coupled with the game bay.

4. The game suite of claim 3, wherein the one or more lounge areas each comprises a viewing area into the game bay.

5. The game suite of claim 3, wherein the one or more lounge areas, the game bay, or both comprises one or more displays configured to display content associated with a selected game.

6. The game suite of claim 5, wherein the content associated with the selected game comprises camera footage within the game bay, digital video gameplay content of the selected game, a leaderboard associated with the selected game, one or more scores associated with the selected game, one or more statistics associated with the selected game, one or more menus associated with the selected game, or a combination thereof

7. The game suite of claim 3, wherein a first one or more of the plurality of user input interfaces are configured to detect input from users within the game bay and a second one or more of the plurality of user input interfaces are configured to detect input from one or more users within the lounge area.

8. The game suite of claim 7, wherein the first one or more of the plurality of user input interfaces comprises one or more motion tracking sensors configured to detect movement of one or more users within the game bay.

9. The game suite of claim 8, wherein the first one or more of the plurality of user input interfaces further comprises one or more connected props, one or more handheld game controllers, or a combination thereof, configured to receive input from the one or more users within the game bay.

10. The game suite of claim 9, wherein the first one or more of the plurality of user input interfaces further comprises one or more audio sensors configured to detect voice commands from the one or more users within the game bay, one or more force sensors configured to detect force applied by the one or more users within the game bay, one or more capacitive touch sensors configured to detect touch of one or more users within the game bay, or a combination thereof.

11. The game suite of claim 7, wherein the second one or more of the plurality of user input interfaces comprises one or more capacitive touch sensors configured to detect touch of one or more users within the game bay.

12. The game suite of claim 11, wherein the second one or more of the plurality of user input interfaces further comprises one or more handheld game controllers configured to receive input from the one or more users within the lounge area.

13. The game suite of claim 11, wherein the second one or more of the plurality of user input interfaces further comprises one or more motion tracking sensors configured to detect movement of one or more users within the lounge area.

14. The game suite of claim 3, wherein the lounge area is coupled to one or more other game bays.

15. The game suite of claim 1, further comprising one or more devices configured to provide 4D elements to one or more uses within the game bay.

16. The game suite of claim 1, wherein the one or more of the one or more walls, the ceiling, and the floor are configured to adjust a positioning in response to the game.

17. The game suite of claim 1, wherein the game bay further comprises a plurality of loudspeakers configured to provide surround audio associated with the game to one or more users within the game bay.

18. The game suite of claim 1, wherein the game suite is modular, and wherein the game bay is configured to couple to one or more other game bays.

19. A method, comprising:
obtaining input from one or more users via one or more user input interfaces of a plurality of user input interfaces within a game suite;
generating visual game content responsive to the input from the one or more users via the one or more user input interfaces; and
displaying projection mapped visual game content to a plurality of one or more walls, a ceiling, or a floor partially enclosing a gaming area of the game suite.

20. A gaming entertainment system, comprising:
a memory comprising computer-executable instructions; and
a processor configured to execute the computer-executable instructions and cause the gaming entertainment system to:
obtain input from one or more users via one or more user input interfaces of a plurality of user input interfaces within a game suite;
generate visual game content responsive to the input from the one or more users via the one or more user input interfaces; and
display projection mapped visual game content to a plurality of one or more walls, a ceiling, or a floor partially enclosing a gaming area of the game suite.
